(19) United States
(12) Patent Application Publication
(10) Pub. No.: US 2023/0038555 A1
(43) Pub. Date: Feb. 9, 2023

(54) Value Exchange and Intelligent Recommendation Engine

(71) Applicant: Bank of America Corporation, Charlotte, NC (US)

(72) Inventors: Monika Kapur, Jacksonville, FL (US); Jo-Ann Taylor, Godalming (GB); Jinna Kim, Charlotte, NC (US); Katherine Dintenfass, Lincoln, RI (US); Karen MacQueen, Lyndhurst, OH (US)

(21) Appl. No.: 17/396,215

(22) Filed: Aug. 6, 2021

(51) Int. Cl. G06Q 30/02; G06N 20/00

(52) U.S. Cl. CPC G06Q 30/0206; G06Q 30/0201; G06Q 30/0253; G06N 20/00; G06Q 30/0208

(57) ABSTRACT

Aspects of the disclosure relate to value exchange and recommendation. A computing platform may send a selection request to a computing device for selecting one or more options for a payment transaction. The one or more options may include a value contribution in exchange for credit. The computing platform may receive, by a user of the computing device, a selection of the value contribution option. The computing platform may initiate performance of the value contribution. The computing platform may receive a notification indicating completion of the value contribution. The computing platform may identify a monetary value of the value contribution. The computing platform may cause a monetary payment to be issued to an account associated with the user of the computing device based on the identified monetary value. The computing platform may generate and send one or more recommendations associated with the payment transaction.

### BACKGROUND

Aspects of the disclosure generally relate to one or more computer systems, servers, and/or other devices including hardware and/or software. In particular, one or more aspects of the disclosure relate to value exchange and personalized intelligent recommendation.

As we move to a cashless society, there are still many individuals who remain “unbanked” (e.g., lack access to a bank account). In many instances, an individual might not have enough money to open an account, might not have the identification documents required to open account, or are unable to, or lack the knowledge to, manage their own money. As a result, the unbanked are often left to rely on costly alternative financial products and services (e.g., provided outside of traditional banking institutions). Such individuals may wish to provide payment in the form of services or goods instead of cash or electronic funds. It may be difficult to use traditional tools to facilitate such transactions.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical problems associated with custom or non-traditional payment transactions. In accordance with one or more embodiments, a computing platform having at least one processor, a communication interface, and memory may, send, to a computing device, a selection request for selecting one or more options for a payment transaction. In addition, the one or more options may include a value contribution in exchange for credit. In response to the selection request, the computing platform may receive, by a user of the computing device, a selection of the value contribution option. Based on the selection, the computing platform may initiate performance of the value contribution by the user of the computing device. The computing platform may receive a notification indicating completion of the value contribution. The computing platform may identify a monetary value of the value contribution. The computing platform may cause a monetary payment to be issued to an account associated with the user of the computing device based on the identified monetary value. The computing platform may generate, using a machine learning model, one or more recommendations associated with the payment transaction. The computing platform may send the one or more recommendations to the computing device.

In some embodiments, initiating the performance of the value contribution by the user may include initiating a performance of a service or a provisioning of one or more goods.

In some arrangements, receiving the notification indicating completion of the value contribution may include receiving an authorization to credit the account associated with the user of the computing device.

In some examples, identifying the monetary value of the value contribution may include determining a market value for the value contribution.

In some embodiments, identifying the monetary value of the value contribution may include performing predictive pricing based on historical data.

In some example arrangements, generating the one or more recommendations associated with the payment transaction may include providing a recommendation to improve a credit score of the user.

In some embodiments, generating the one or more recommendations associated with the payment transaction may include providing a recommendation for pricing a service.

In some examples, generating the one or more recommendations associated with the payment transaction may include offering one or more incentives that are eligible for application to the payment transaction.

In some embodiments, causing the monetary payment to be issued to the account associated with the user of the computing device may include issuing a universally accepted monetary representation to the account associated with the user of the computing device.

In some arrangements, causing the monetary payment to be issued to the account associated with the user of the computing device may include providing real-time recognition of the monetary payment to the account associated with the user of the computing device.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing environment for value exchange and intelligent recommendation in accordance with one or more example embodiments;

FIGS. 2A-2G depict an illustrative event sequence for value exchange and intelligent recommendation in accordance with one or more example embodiments;

FIGS. 3 and 4 depict example graphical user interfaces for value exchange and intelligent recommendation in accordance with one or more example embodiments; and

FIG. 5 depicts an illustrative method for value exchange and intelligent recommendation in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

Some aspects of the disclosure relate to custom or non-traditional payment transactions involving non-cash exchange options. In particular, one or more aspects of the disclosure allow unbanked or underbanked individuals (e.g., who might not have bank accounts or who use nonbank financial services, have limited options for banking in traditional financial institutions, or the like), to engage or gain access to various services of a financial institution. Additional aspects of the disclosure may provide a value exchange and recommendation computing platform for monitoring user activity, detecting trends, and generating recommendations (e.g. providing recommendations for next steps, such as guiding users on building assets, guiding users on building credit, offering rewards or incentives, directing users to resources and tools, and/or the like). Further aspects of the disclosure may facilitate the provision of services or goods for payment.

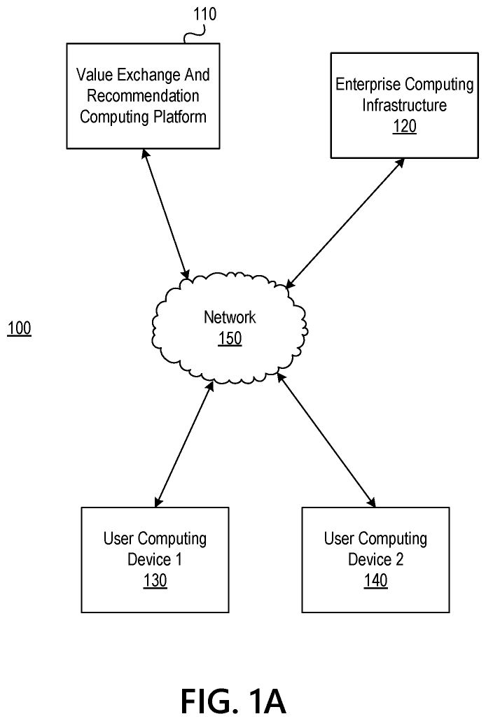

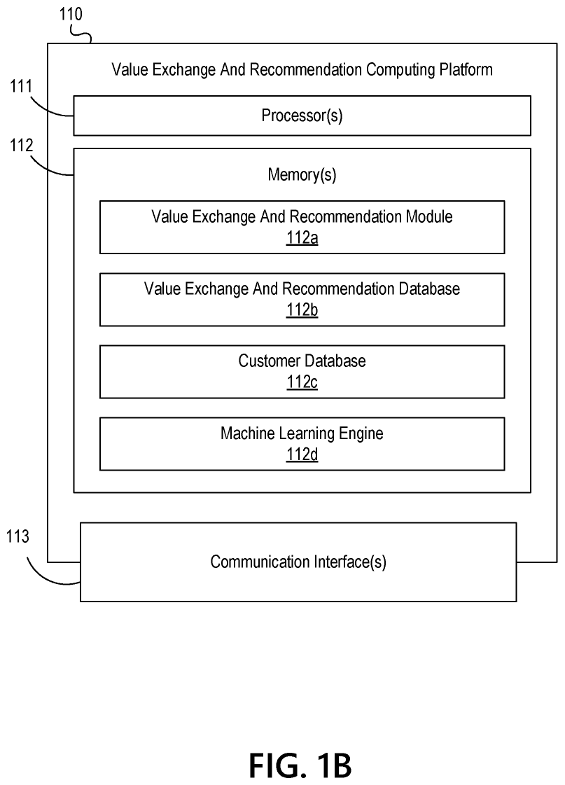

FIGS. 1A and 1B depict an illustrative computing environment for value exchange and intelligent recommendation in accordance with one or more example embodiments. Referring to FIG. 1A, computing environment 100 may include one or more computing devices and/or other computing systems. For example, computing environment 100 may include value exchange and recommendation computing platform 110, enterprise computing infrastructure 120, a first user computing device 130, and a second user computing device 140. Although two user computing devices are shown for illustrative purposes, any number of user computing devices may be included without departing from the disclosure.

As illustrated in greater detail below, value exchange and recommendation computing platform 110 may include one or more computing devices configured to perform one or more of the functions described herein. For example, value exchange and recommendation computing platform 110 may include one or more computers (e.g., laptop computers, desktop computers, servers, server blades, or the like).

In one or more arrangements, value exchange and recommendation computing platform 110 may be associated with an enterprise organization, such as a financial institution, and value exchange and recommendation computing platform 110 may be connected to other servers and/or enterprise computing infrastructure 120 that is configured to provide various enterprise and/or back-office computing functions for the enterprise organization. For example, this enterprise computing infrastructure 120 may include various servers and/or databases that store and/or otherwise maintain account information, such as financial account information including account balances, transaction history, account owner information, and/or other information. In addition, enterprise computing infrastructure 120 may process and/or otherwise execute transactions on specific accounts based on commands and/or other information received from other computer systems included in computing environment 100.

User computing device 130 may include one or more computing devices and/or other computer components (e.g., processors, memories, communication interfaces). For instance, user computing device 130 may be a server, desktop computer, laptop computer, tablet, mobile device, or the like, and may be used by a first user (who may, e.g., be individually and/or uniquely recognized by user computing device 130 and/or value exchange and recommendation computing platform 110). Similar to user computing device 130, user computing device 140 may include one or more computing devices and/or other computer components (e.g., processors, memories, communication interfaces). For instance, user computing device 140 may be a server, desktop computer, laptop computer, tablet, mobile device, or the like, and may be used by a second user (who may, e.g., be individually and/or uniquely recognized by user computing device 140 and/or value exchange and recommendation computing platform 110), and the second user associated with user computing device 140 may be different from the first user associated with user computing device 130.

Computing environment 100 also may include one or more networks, which may interconnect one or more of value exchange and recommendation computing platform 110, enterprise computing infrastructure 120, user computing device 130, and user computing device 140. For example, computing environment 100 may include network 150. Network 150 may include one or more sub-networks (e.g., local area networks (LANs), wide area networks (WANs), or the like). For example, network 150 may include a private sub-network that may be associated with a particular organization (e.g., a corporation, financial institution, educational institution, governmental institution, or the like) and that may interconnect one or more computing devices associated with the organization. For example, value exchange and recommendation computing platform 110 and enterprise computing infrastructure 120 may be associated with an organization (e.g., a financial institution), and network 150 may be associated with and/or operated by the organization, and may include one or more networks (e.g., LANs, WANs, virtual private networks (VPNs), or the like) that interconnect value exchange and recommendation computing platform 110 and enterprise computing infrastructure 120. Network 150 also may include a public sub-network that may connect the private sub-network and/or one or more computing devices connected thereto (e.g., value exchange and recommendation computing platform 110 and enterprise computing infrastructure 120) with one or more networks and/or computing devices that are not associated with the organization (e.g., user computing device 130, user computing device 140).

In one or more arrangements, value exchange and recommendation computing platform 110, enterprise computing infrastructure 120, user computing device 130, and user computing device 140 may be any type of computing device capable of receiving a user interface, receiving input via the user interface, and communicating the received input to one or more other computing devices. For example, value exchange and recommendation computing platform 110, enterprise computing infrastructure 120, user computing device 130, user computing device 140, and/or the other systems included in computing environment 100 may, in some instances, include one or more processors, memories, communication interfaces, storage devices, and/or other components. As noted above, and as illustrated in greater detail below, any and/or all of the computing devices included in computing environment 100 may, in some instances, be special-purpose computing devices configured to perform specific functions.

Referring to FIG. 1B, value exchange and recommendation computing platform 110 may include one or more processor(s) 111, memory(s) 112, and communication interface(s) 113. A data bus may interconnect processor 111, memory 112, and communication interface 113. Communication interface 113 may be a network interface configured to support communication between value exchange and recommendation computing platform 110 and one or more networks (e.g., network 150 or the like). Memory 112 may include one or more program modules having instructions that when executed by processor 111 cause value exchange and recommendation computing platform 110 to perform one or more functions described herein and/or one or more databases and/or other libraries that may store and/or otherwise maintain information which may be used by such program modules and/or processor 111.

In some instances, the one or more program modules and/or databases may be stored by and/or maintained in different memory units of value exchange and recommendation computing platform 110 and/or by different computing devices that may form and/or otherwise make up value exchange and recommendation computing platform 110. For example, memory 112 may have, store, and/or include a value exchange and recommendation module 112a, a value exchange and recommendation database 112b, a customer database 112c, and a machine learning engine 112d. Value exchange and recommendation module 112a may have instructions that direct and/or cause value exchange and recommendation computing platform 110 to perform value exchange and generate recommendations and/or perform other functions, as discussed in greater detail below. Value exchange and recommendation database 112b may store information used by value exchange and recommendation module 112a and/or value exchange and recommendation computing platform 110 in performing value exchange and generating recommendations and/or in performing other functions. Customer database 112c may store information (e.g., customer information, account information, and/or the like) used by value exchange and recommendation module 112a and/or value exchange and recommendation computing platform 110 in conducting value exchange and generating recommendations and/or in performing other functions. Machine learning engine 112d may have instructions that direct and/or cause value exchange and recommendation computing platform 110 to set, define, and/or iteratively redefine rules, techniques and/or other parameters used by value exchange and recommendation computing platform 110 and/or other systems in computing environment 100 in performing value exchange and generating recommendations using machine learning.

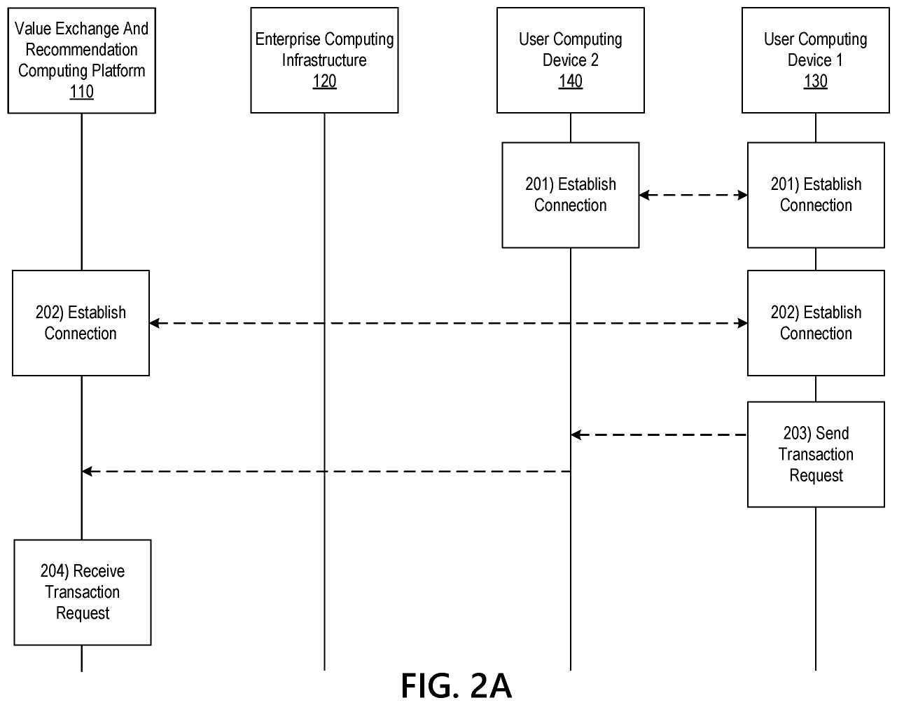

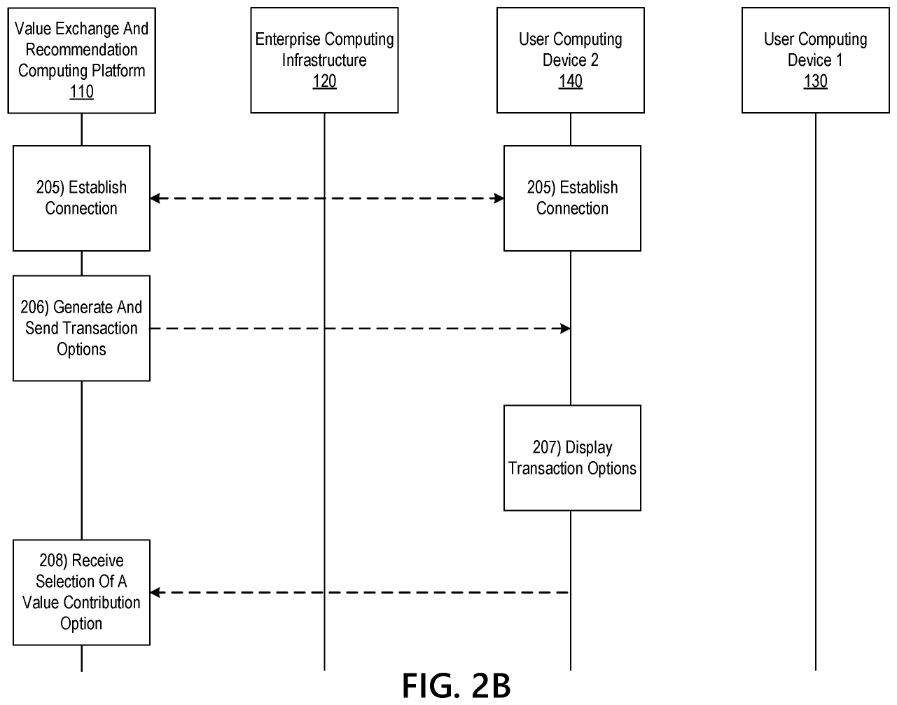

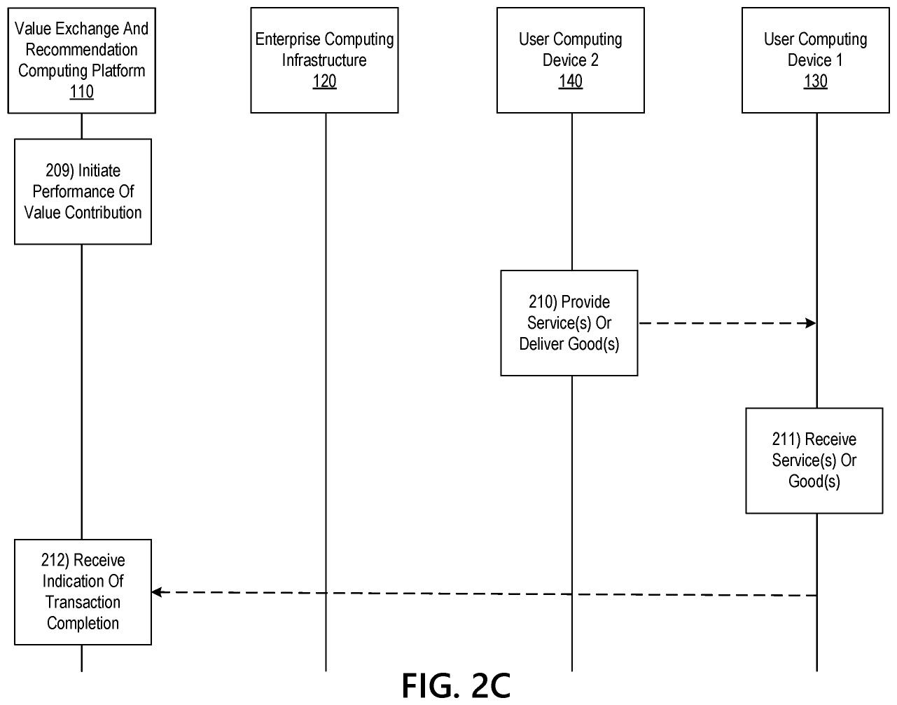

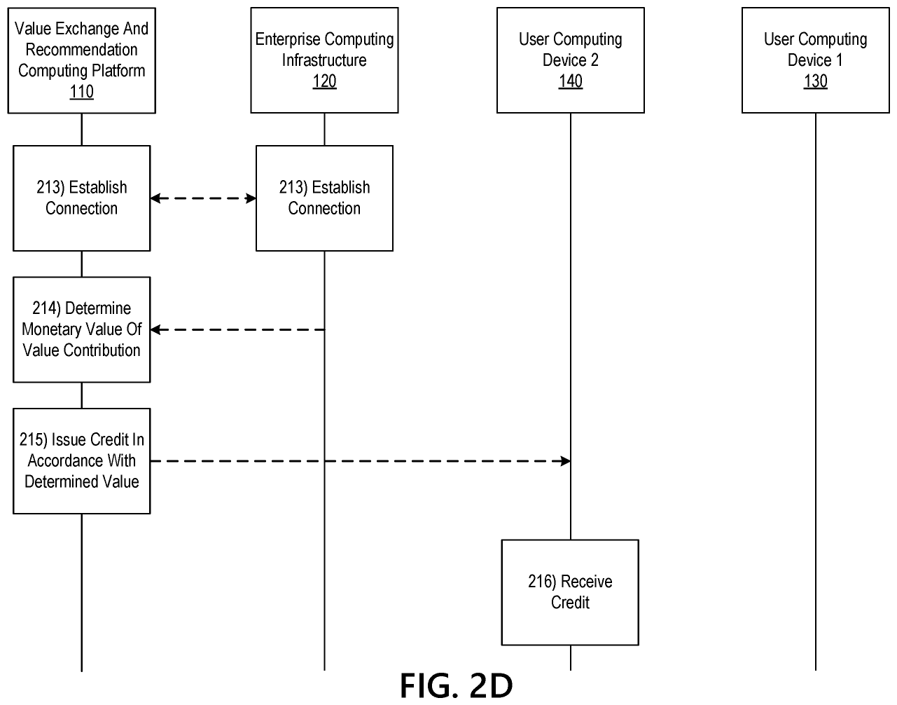

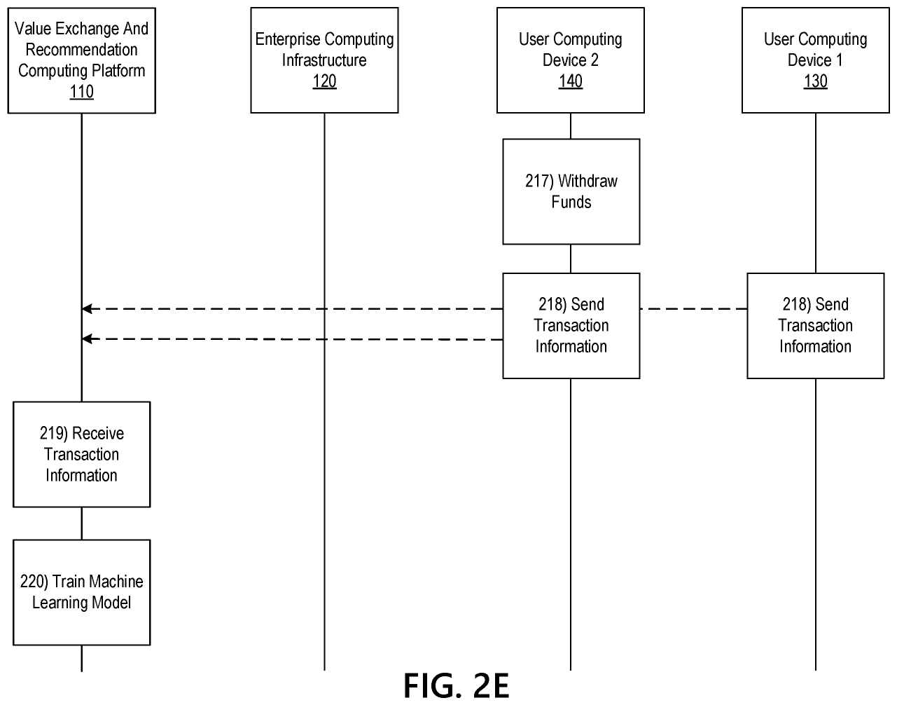

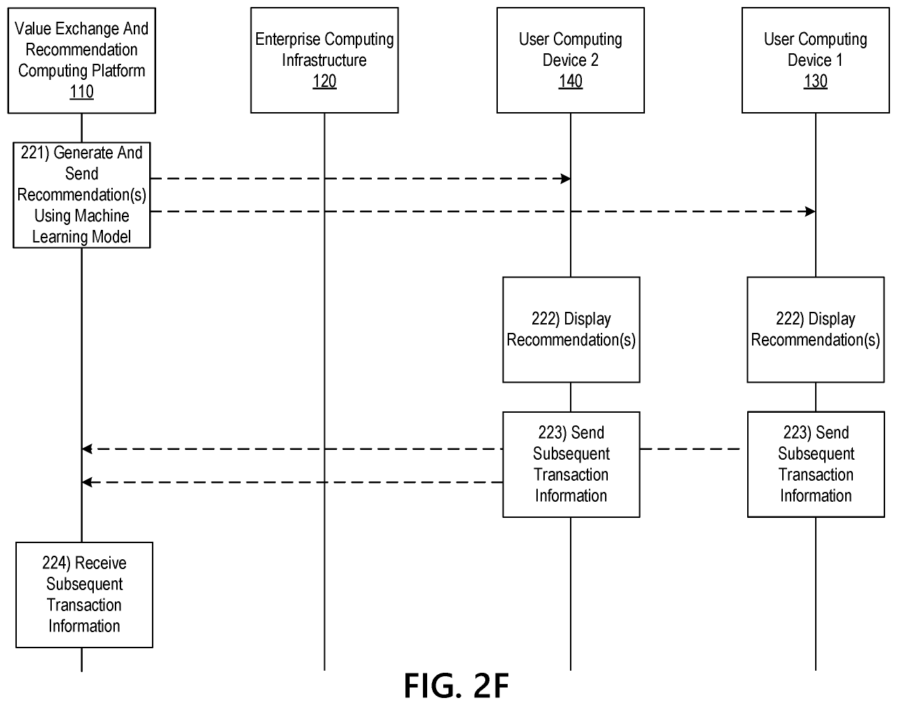

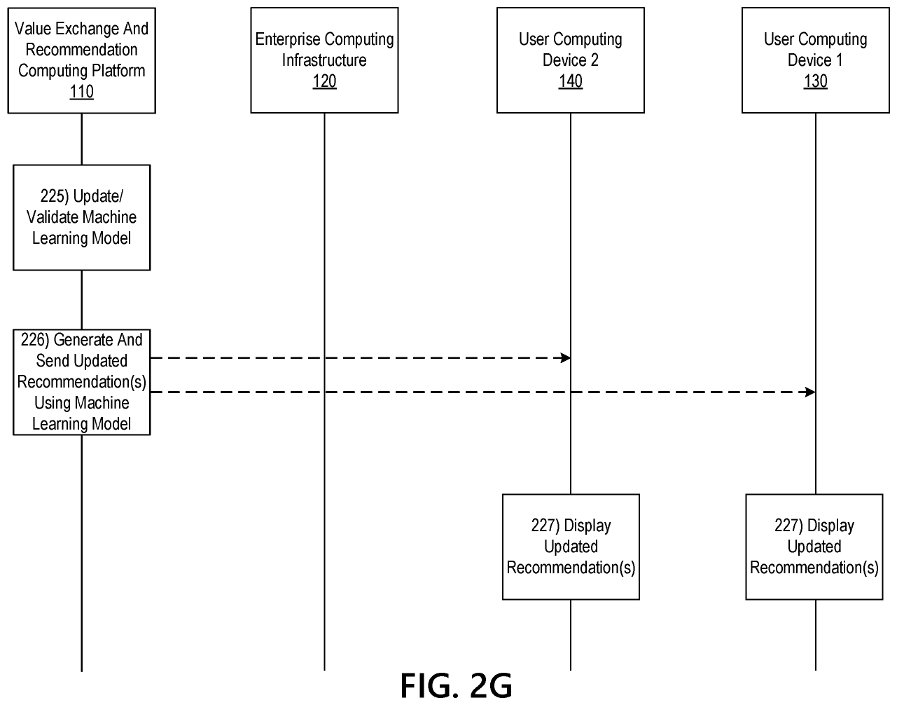

FIGS. 2A-2G depict an illustrative event sequence for value exchange and intelligent recommendation in accordance with one or more example embodiments. Referring to FIG. 2A, at step 201, a user of a first computing device (e.g., user computing device 130) may establish a connection with a user of a second computing device (e.g., user computing device 140). For example, the user of the first computing device (e.g., user computing device 130) may establish a first wireless data connection with the user of the second computing device (e.g., user computing device 140) to link the user of the second computing device (e.g., user computing device 140) with the user of the first computing device (e.g., user computing device 130) (e.g., in preparation for sending transaction requests). In some instances, the user of the first computing device (e.g., user computing device 130) may identify whether or not a connection is already established with the user of the second computing device (e.g., user computing device 140). If a connection is already established with the user of the second computing device (e.g., user computing device 140), the user of the first computing device (e.g., user computing device 130) might not re-establish the connection. If a connection is not yet established with the user of the second computing device (e.g., user computing device 140), the user of the first computing device (e.g., user computing device 130) may establish the first wireless data connection as described above.

At step 202, a user of a first computing device (e.g., user computing device 130) may establish a connection with value exchange and recommendation computing platform 110. For example, the user of the first computing device (e.g., user computing device 130) may establish a second wireless data connection with value exchange and recommendation computing platform 110 to link value exchange and recommendation computing platform 110 with the user of the first computing device (e.g., user computing device 130) (e.g., in preparation for sending transaction requests). In some instances, the user of the first computing device (e.g., user computing device 130) may identify whether or not a connection is already established with value exchange and recommendation computing platform 110. If a connection is already established with value exchange and recommendation computing platform 110, the user of the first computing device (e.g., user computing device 130) might not re-establish the connection. If a connection is not yet established with value exchange and recommendation computing platform 110, the user of the first computing device (e.g., user computing device 130) may establish the second wireless data connection as described above.

At step 203, the user of the first computing device (e.g., user computing device 130) may initiate a transaction (e.g., a payment transaction) with the user of the second computing device (e.g., user computing device 140). For example, the user of the first computing device (e.g., user computing device 130) may initiate a request for payment while the first wireless data connection is established. In turn, at step 204, value exchange and recommendation computing platform 110 may receive, via the communication interface (e.g., communication interface 113) and while the second wireless data connection is established, the transaction request (e.g., the payment request) initiated at the first computing device (e.g. user computing device 130).

Referring to FIG. 2B, at step 205, value exchange and recommendation computing platform 110 may establish a connection with second computing device (e.g., user computing device 140). For example, value exchange and recommendation computing platform 110 may establish a third wireless data connection with second computing device (e.g., user computing device 140) to link value exchange and recommendation computing platform 110 with second computing device (e.g., user computing device 140). In some instances, value exchange and recommendation computing platform 110 may identify whether or not a connection is already established with second computing device (e.g., user computing device 140). If a connection is already established with second computing device (e.g., user computing device 140), value exchange and recommendation computing platform 110 might not re-establish the connection. If a connection is not yet established with the second computing device (e.g., user computing device 140), value exchange and recommendation computing platform 110 may establish the third wireless data connection as described above.

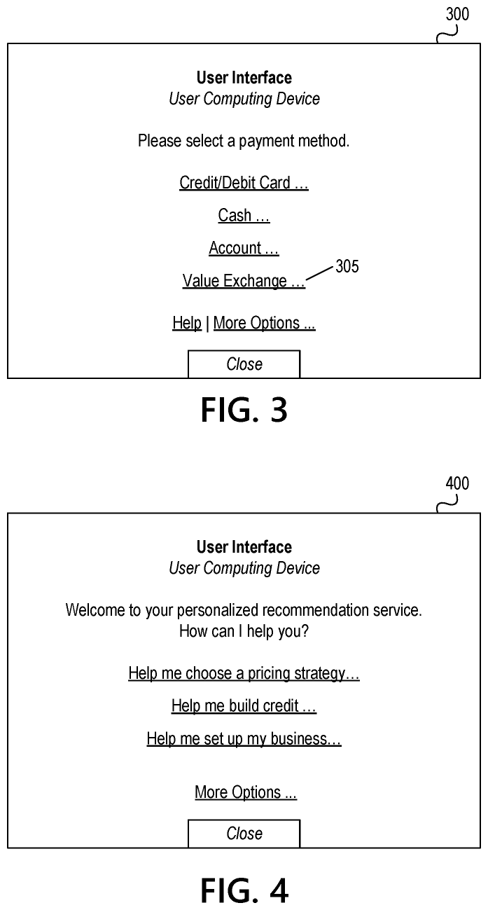

At step 206, value exchange and recommendation computing platform 110 may generate and send, via the communication interface (e.g., communication interface 113) and while the third wireless data connection is established, a selection request to the second computing device (e.g., user computing device 140) for selecting one or more options for transaction (e.g., a payment transaction). In some examples, the one or more options may include a value contribution in exchange for credit. For example, at step 207, the second computing device (e.g., user computing device 140) may display transaction options. For example, value exchange and recommendation computing platform 110 may cause the second user computing device (e.g., user computing device 140) to display and/or otherwise present one or more graphical user interfaces similar to graphical user interface 300, which is illustrated in FIG. 3. As seen in FIG. 3, graphical user interface 300 may include text and/or other information associated with a payment transaction, including one or more user-selectable options that allow a user to select from one or more methods or types of payment options (e.g., “Please select a payment method. [Credit/Debit Card . . . ] [Cash . . . ] [Account . . . ] [Value Exchange . . . ]”). It will be appreciated that other and/or different notifications may also be provided.

At step 208, value exchange and recommendation computing platform 110 may receive, via the communication interface (e.g., communication interface 113), by the user of the second computing device (e.g., user of user computing device 140), a selection of the value contribution option (e.g., 305 in FIG. 3).

Referring to FIG. 2C, at step 209, value exchange and recommendation computing platform 110 may initiate performance of the value contribution (e.g., by the user of user computing device 140). For instance, at steps 210 to 211, value exchange and recommendation computing platform 110 may initiate a value exchange between the user of the first computing device (e.g., user of user computing device 130) and the user of the second computing device (e.g., user of user computing device 140). For example, value exchange and recommendation computing platform 110 may initiate performance of a service (e.g., by a service provider who may provide cleaning, childcare, or other services) or a provisioning of one or more goods (e.g., by a goods provider who may sell items such as homemade goods or home-grown produce).

At step 212, value exchange and recommendation computing platform 110 may receive, via the communication interface (e.g., communication interface 113) and while the second wireless data connection is established, a notification indicating completion of the value contribution. In receiving the notification indicating completion of the value contribution value exchange and recommendation computing platform 110 may receive an authorization (e.g., by the user of user computing device 130) to credit the account associated with the user of the second computing device (e.g., user of user computing device 140).

With reference to FIG. 2D, at step 213, value exchange and recommendation computing platform 110 may establish a connection with enterprise computing infrastructure 120. For example, value exchange and recommendation computing platform 110 may establish a fourth wireless data connection with enterprise computing infrastructure 120 to link value exchange and recommendation computing platform 110 with enterprise computing infrastructure 120. In some instances, value exchange and recommendation computing platform 110 may identify whether or not a connection is already established with the enterprise computing infrastructure 120. If a connection is already established with enterprise computing infrastructure 120, value exchange and recommendation computing platform 110 may not re-establish the connection. If a connection is not yet established with enterprise computing infrastructure 120, value exchange and recommendation computing platform 110 may establish the fourth wireless data connection as described above.

At step 214, value exchange and recommendation computing platform 110 may identify a monetary value or some other calculable value of the value contribution. In identifying the monetary value of the value contribution, value exchange and recommendation computing platform 110 may, for example, determine a market value for the value contribution or perform predictive pricing based on aggregate or historical data stored in enterprise computing infrastructure 120 or other data store (e.g., customer database 112c) while the fourth wireless data connection is established. In some embodiments, the monetary value of the value contribution may be set or determined by the service provider or the goods provider (e.g., user of user computing device 140). In some embodiments, the monetary value of the value contribution may be based on location, trends, demand, current market pricing, anticipated potential price changes, and/or the like.

At step 215, based on the identified monetary value of the value contribution, value exchange and recommendation computing platform 110 may cause a credit (e.g., monetary payment) or other measurable compensation to be issued to the account associated with the user of the second user computing device (e.g., user of user computing device 140), for example, while the third wireless data connection is established. In turn, at step 216, the user of the second user computing device (e.g., user of user computing device 140) may receive the credit (e.g., monetary payment). In some examples, the credit (e.g., monetary payment) issued to the account associated with the user of the second user computing device (e.g., user of user computing device 140) may be and/or include a universally accepted monetary representation (e.g., universally accepted worldwide by merchants of any kind). In some examples, value exchange and recommendation computing platform 110 may provide real-time recognition of the credit (e.g., monetary payment) to the account associated with the user of the second user computing device (e.g., user of user computing device 140). Thereby, value exchange and recommendation computing platform 110 may provide users with immediate access to the credit issued to their account.

Referring to FIG. 2E, in some embodiments, at step 217, the user of the second computing device (e.g., user of user computing device 140) may use the credit to purchase goods or pay for services, to make electronic payments (e.g., to fulfill the payment request from user computing device 130 at step 201), or to withdraw the funds (e.g., in the form of cash).

At steps 218 to 219, value exchange and recommendation computing platform 110 may monitor transactions and asset/liability account and balances associated with the user computing devices (e.g., user computing device 130, user computing device 140). For example, at step 218, user computing device 130 and/or user computing device 140 may send historical transaction information to value exchange and recommendation computing platform 110. For example, user computing device 130 and/or user computing device 140 may send historical transaction information to value exchange and recommendation computing platform 110 while the second and/or third wireless data connections are established.

In some instances, in sending the historical transaction information, user computing device 130 and/or user computing device 140 may send prior transaction processing requests, determinations of asset/liability account and balances associated with the user computing devices (e.g., user computing device 130, user computing device 140), and/or other information. In some instances, the prior transaction processing requests may include commercial transactions, currency transfers, and/or other activities. In some instances, the prior transaction processing requests may have been made by the first user via the first user computing device 130 and/or a banking device, mobile device, application, and/or other methods. In some instances, the prior transaction processing requests may have been made by the second user via the second user computing device 140 and/or a banking device, mobile device, application, and/or other methods.

At step 219, value exchange and recommendation computing platform 110 may receive the historical transaction information from user computing device 130 and/or user computing device 140. For example, value exchange and recommendation computing platform 110 may receive the historical transaction information via the communication interface 113 and while the second and/or third wireless data connection are established. In some instances, the historical transaction information may be stored in internal memory of value exchange and recommendation computing platform 110, and/or external memory.

At step 220, exchange and recommendation computing platform 110 may configure and/or otherwise train a machine learning model (e.g., via machine learning engine 112d) based on the data received at step 219. In some instances, to configure and/or otherwise train the machine learning model, exchange and recommendation computing platform 110 may process all (or a subset) of the data received at step 219 by applying natural language processing and/or other processing techniques/algorithms to generate and store one or more classification models.

For example, in configuring and/or otherwise training the machine learning model, exchange and recommendation computing platform 110 may apply natural language processing to the historical transaction information to identify keywords in the prior transaction processing requests to group the prior transaction processing requests based on those identified keywords. For instance, exchange and recommendation computing platform 110 may identify that all transaction processing requests corresponding to a value exchange transaction at a particular geographic region (e.g. a neighborhood, city, state, and/or other geographic region) should be grouped together. For example, based on the historical transaction information received at step 219, exchange and recommendation computing platform 110 may identify that all transaction processing requests corresponding to a value exchange transaction in a first geographic region should be grouped together.

Additionally or alternatively, in configuring and training the machine learning model, exchange and recommendation computing platform 110 may also analyze the historical transaction information for past user transactions to determine next steps or further action that may be taken. For example, based on a user's past transactions to perform a value contribution to provide cleaning services in a first geographic region, exchange and recommendation computing platform 110 may instruct the machine learning model to automatically recommend next steps or further action that may be taken. Additionally or alternatively, exchange and recommendation computing platform 110 may give the machine learning model this instruction based on the user's past transactions.

Referring to FIG. 2F, at step 221, based on the trained machine learning model, value exchange and recommendation computing platform 110 may generate one or more recommendations associated with the transaction (e.g., the payment transaction), and send, via the communication interface (e.g., communication interface 113), the one or more recommendations to the one or more user computing devices (e.g., user computing device 130 and/or user computing device 140). In generating the one or more recommendations associated with the transaction (e.g., the payment transaction), value exchange and recommendation computing platform 110 may, for example, provide a recommendation for pricing a service or good offered by the user, provide a recommendation to improve a credit score of the user, provide a recommendation for setting up a business (e.g., the financial outlay that may be required to start up a business), provide the user with suggestions on next steps or further action that may be taken, offer one or more incentives that are eligible for application to the transaction (e.g., financial incentives or reward programs), and/or the like while the second and/or third wireless data connection are established. In some examples, the one or more recommendations may be provided in a user preferred language.

At step 222, value exchange and recommendation computing platform 110 may cause the one or more user computing devices (e.g., user computing device 130 and/or user computing device 140) to display the one or more recommendations. For example, value exchange and recommendation computing platform 110 may cause the user computing device (e.g., user computing device 130 and/or user computing device 140) to display and/or otherwise present one or more graphical user interfaces similar to graphical user interface 400, which is illustrated in FIG. 4. As seen in FIG. 4, graphical user interface 400 may include text and/or other information associated with providing intelligent personalized recommendations (e.g., “Welcome to your personalized recommendation service. How may I help you? [Help me choose a pricing strategy . . . ] [Help me build credit . . . ] [Help me set up my business . . . ]”). It will be appreciated that other and/or different notifications may also be provided.

At steps 223 to 224, value exchange and recommendation computing platform 110 may monitor subsequent transactions and asset/liability account and balances associated with the user computing devices (e.g., user computing device 130, user computing device 140). For example, at step 223, user computing device 130 and/or user computing device 140 may send subsequent transaction information to value exchange and recommendation computing platform 110. For example, user computing device 130 and/or user computing device 140 may send subsequent transaction information to value exchange and recommendation computing platform 110 while the second and/or third wireless data connections are established.

At step 224, value exchange and recommendation computing platform 110 may receive the subsequent transaction information from user computing device 130 and/or user computing device 140. For example, value exchange and recommendation computing platform 110 may receive the subsequent transaction information via the communication interface 113 and while the second and/or third wireless data connection are established. In some instances, the subsequent transaction information may be stored in internal memory of value exchange and recommendation computing platform 110, and/or external memory.

Referring to FIG. 2G, at step 225, exchange and recommendation computing platform 110 may update and/or validate the machine learning model (e.g., via machine learning engine 112d) based on the subsequent data received at step 224. In turn, at step 226, based on the updated/validated machine learning model, value exchange and recommendation computing platform 110 may generate one or more updated recommendations associated with the transaction (e.g., the payment transaction), and send, via the communication interface (e.g., communication interface 113), the one or more updated recommendations to the one or more user computing devices (e.g., user computing device 130 and/or user computing device 140). At step 227, value exchange and recommendation computing platform 110 may cause the one or more user computing devices (e.g., user computing device 130 and/or user computing device 140) to display the updated one or more recommendations.

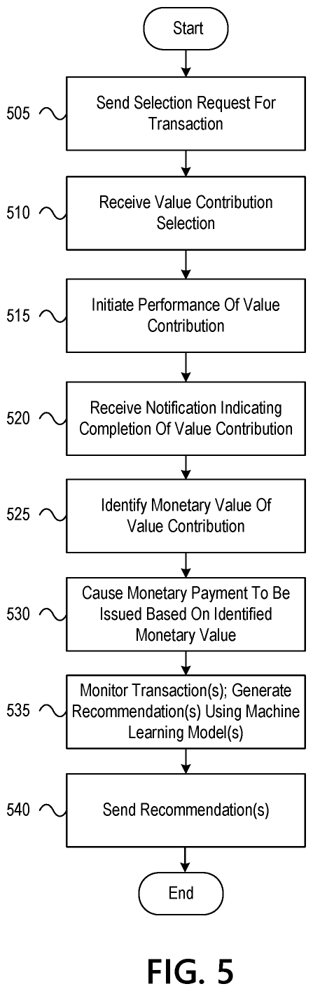

FIG. 5 depicts an illustrative method for value exchange and intelligent recommendation in accordance with one or more example embodiments. Referring to FIG. 5, at step 505, a computing platform having at least one processor, a communication interface, and memory may, send a selection request to a computing device for selecting one or more options for a payment transaction. In addition, the one or more options may include a value contribution in exchange for credit. At step 510, the computing platform may receive, by a user of the computing device, a selection of the value contribution option. At step 515, the computing platform may initiate, based on the received selection, performance of the value contribution by the user of the computing device. At step 520, the computing platform may receive a notification indicating completion of the value contribution. At step 525, the computing platform may identify a monetary value of the value contribution. At step 530, the computing platform may cause a monetary payment to be issued to an account associated with the user of the computing device based on the identified monetary value. At step 535, the computing platform may generate, using a machine learning model, one or more recommendations associated with the payment transaction. At step 540, the computing platform may send the one or more recommendations to the computing device.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

1. A computing platform, comprising:
at least one processor;
a communication interface communicatively coupled to the at least one processor; and
memory storing computer-readable instructions that, when executed by the at least one processor, cause the computing platform to:
receive, from a plurality of computing devices, historical transaction data;
train, by a machine learning engine, a machine learning model, training the machine learning model including:
identifying, by applying natural language processing to the historical transaction data, keywords;
grouping, based on the identified keywords, the historical data;
send, via the communication interface, to a computing device of the plurality of computing devices, a user interface including a selection request for selecting one or more options for a payment transaction, wherein the one or more options include at least cash, credit card or a value contribution in exchange for credit;
receive, from the computing device and via the user interface, a selection of the value contribution option;
initiate, based on the received selection, performance of the value contribution by the user of the computing device, wherein initiating performance of the value contribution includes one of: performing a service or provisioning goods;
receive, via the communication interface, a notification indicating completion of the value contribution;
identify a monetary value of the value contribution;
cause a monetary payment to be issued to an account associated with the user of the computing device based on the identified monetary value;
generate, using the machine learning model, one or more recommendations associated with the payment transaction; and
send, via the communication interface, the one or more recommendations to the computing device.

2. (canceled)

3. The computing platform of claim 1, wherein receiving the notification indicating completion of the value contribution comprises receiving an authorization to credit the account associated with the user of the computing device.

4. The computing platform of claim 1, wherein identifying the monetary value of the value contribution comprises determining a market value for the value contribution.

5. The computing platform of claim 1, wherein identifying the monetary value of the value contribution comprises performing predictive pricing based on historical data.

6. The computing platform of claim 1, wherein generating the one or more recommendations associated with the payment transaction comprises providing a recommendation to improve a credit score of the user.

7. The computing platform of claim 1, wherein generating the one or more recommendations associated with the payment transaction comprises providing a recommendation for pricing a service.

8. The computing platform of claim 1, wherein generating the one or more recommendations associated with the payment transaction comprises offering one or more incentives that are eligible for application to the payment transaction.

9. The computing platform of claim 1, wherein causing the monetary payment to be issued to the account associated with the user of the computing device comprises issuing a universally accepted monetary representation to the account associated with the user of the computing device.

10. The computing platform of claim 1, wherein causing the monetary payment to be issued to the account associated with the user of the computing device comprises providing real-time recognition of the monetary payment to the account associated with the user of the computing device.

11. A method, comprising:
at a computing platform comprising at least one processor, a communication interface, and memory:
receiving, by the at least one processor and from a plurality of computing devices, historical transaction data;
training, by a machine learning engine, a machine learning model, training the machine learning model including:
identifying, by applying natural language processing to the historical transaction data, keywords;
grouping, based on the identified keywords, the historical data;
sending, by the at least one processor, via the communication interface, to a computing device of the plurality of computing devices, a user interface including a selection request for selecting one or more options for a payment transaction, wherein the one or more options include at least cash, credit card, or a value contribution in exchange for credit;
receiving, by the at least one processor, from the computing device and via the user interface, a selection of the value contribution option;
initiating, by the at least one processor, based on the received selection, performance of the value contribution by the user of the computing device, wherein initiating performance of the value contribution includes one of: performing a service or provisioning goods;
receiving, by the at least one processor, via the communication interface, a notification indicating completion of the value contribution;
identifying, by the at least one processor, a monetary value of the value contribution;
causing, by the at least one processor, a monetary payment to be issued to an account associated with the user of the computing device based on the identified monetary value;
generating, by the at least one processor, using the machine learning model, one or more recommendations associated with the payment transaction; and
sending, by the at least one processor, via the communication interface, the one or more recommendations to the computing device.

12. (canceled)

13. The method of claim 11, wherein receiving the notification indicating completion of the value contribution comprises receiving an authorization to credit the account associated with the user of the computing device.

14. The method of claim 11, wherein identifying the monetary value of the value contribution comprises determining a market value for the value contribution.

15. The method of claim 11, wherein identifying the monetary value of the value contribution comprises performing predictive pricing based on historical data.

16. The method of claim 11, wherein generating the one or more recommendations associated with the payment transaction comprises providing a recommendation to improve a credit score of the user.

17. The method of claim 11, wherein generating the one or more recommendations associated with the payment transaction comprises providing a recommendation for pricing a service.

18. The method of claim 11, wherein generating the one or more recommendations associated with the payment transaction comprises offering one or more incentives that are eligible for application to the payment transaction.

19. The method of claim 11, wherein causing the monetary payment to be issued to the account associated with the user of the computing device comprises issuing a universally accepted monetary representation to the account associated with the user of the computing device.

20. One or more non-transitory computer-readable media storing instructions that, when executed by a computing platform comprising at least one processor, a communication interface, and memory, cause the computing platform to:
receive, from a plurality of computing devices, historical transaction data;
train, by a machine learning engine, a machine learning model, training the machine learning model including:
identifying, by applying natural language processing to the historical transaction data, keywords;
grouping, based on the identified keywords, the historical data;
send, via the communication interface, to a computing device of the plurality of computing devices, a user interface including a selection request for selecting one or more options for a payment transaction, wherein the one or more options include at least cash, credit card, and a value contribution in exchange for credit;
receive, from the computing device and via the user interface, a selection of the value contribution option;
initiate, based on the received selection, performance of the value contribution by the user of the computing device, wherein initiating performance of the value contribution includes one of: performing a service or provisioning goods;
receive, via the communication interface, a notification indicating completion of the value contribution;
identify a monetary value of the value contribution;
causing a monetary payment to be issued to an account associated with the user of the computing device based on the identified monetary value;
generate, using the machine learning model, one or more recommendations associated with the payment transaction; and
send, via the communication interface, the one or more recommendations to the computing device.
